(19) United States
(12) Patent Application Publication
(10) Pub. No.: US 2004/0046636 A1
(43) Pub. Date: Mar. 11, 2004

(54) Method of producing ceramic thermistor chips

(75) Inventors: Yasunori Ito, Shiga (JP); Masahiko Kawase, Shiga (JP)

Correspondence Address: BEYER WEAVER & THOMAS LLP, P.O. BOX 778, BERKELEY, CA, 94704-0778, US

(73) Assignee: Murata Manufacturing Co., Ltd.

(21) Appl. No.: 10/640,850

(22) Filed: Aug. 13, 2003

Related U.S. Application Data
(62) Division of application No. 09/392,466, filed on Sep. 9, 1999, now abandoned.

(30) Foreign Application Priority Data
Sep. 11, 1998 (JP) 10-258050

(51) Int. Cl. H01C 7/10; H01C 7/13

(52) U.S. Cl. 338/22 R

(57) ABSTRACT

A ceramic thermistor chip has outer electrodes electrolytically formed on both end parts of a ceramic thermistor element and the portions of the surface of the ceramic thermistor element not covered by these outer electrodes are entirely covered by an organic insulating layer such as an acrylate resin layer or a ceramic layer with specific resistance greater than that of the thermistor element such as a material having as its principal component one or more oxides containing two or more metals selected from Mn, Ni, Co, Fe, Cu and Al and one or more metals selected from Zn, Al, W, Zr, Sb, Y, Sm, Ti and Fe.

### BACKGROUND OF THE INVENTION

This invention relates to ceramic thermistors in the form of chips (“ceramic thermistor chips”) for surface mounting. The invention also relates to a method of producing such ceramic thermistor chips.

Prior art ceramic thermistor chips are produced by using baked Ag electrodes to form outer electrodes on its both end portions, but it is preferable to form solder layers by electrolytic plating on the baked Ag electrodes in order to improve the wettability to solder and the resistance of the solder against heat. In the case of ceramic thermistor chips, and particularly in the case of ceramic thermistor chips made of a material with low specific resistance, however, the solder may be deposited, at the time of the electrolytic plating, on the portions of the surface of the ceramic thermistor element other than the areas where the outer electrodes are to be formed. There are also other problems such as the changes which may take place in the value of the resistance due to corrosion or melting of the thermistor element. For this reason, it has been known to form glass layers on the portions of the surface of the ceramic thermistor element except for the areas where the outer electrodes are to be formed such that the deposition of the solder on the surface of the ceramic thermistor element as well as the corrosion of the surface of the ceramic thermistor element at the time of the electrolytic plating process can be prevented.

FIG. 5 shows a prior art ceramic thermistor chip 1 thus structured. Outer electrodes 3 are formed on both end parts of a ceramic thermistor element 2 and glass layers 4 cover the portions of the surface of the ceramic thermistor element 2 not covered by the outer electrodes 3. To produce such a ceramic thermistor chip 1, a thick-film Ag paste is applied to both end parts of the ceramic thermistor element 2 and baked to form baked Ag electrode layers 3a serving as base layers. Next, the glass layers 4 are formed on the surface of the ceramic thermistor element 2, and thereafter Ni layers 3b and Sn layers 3c are formed by electrolytic plating.

The ceramic thermistor chip 1 and the method of its production, as described above, have the problem of low productivity and high cost because of the production step of applying and baking a thick-film Ag paste on both end parts of a sintered ceramic thermistor element.

### SUMMARY OF THE INVENTION

It is therefore an object of this invention to provide a new kind of ceramic thermistor chip which can be produced at a reduced cost and a method of producing such ceramic thermistor chips.

A ceramic thermistor chip embodying this invention, with which the above and other objects can be accomplished, may be characterized not only as having outer electrodes formed on both end parts of a ceramic thermistor element but also wherein the portions of the surface of the ceramic thermistor element not covered by the outer electrodes are entirely covered by an organic insulating layer or a ceramic layer with specific resistance greater than that of the thermistor element.

According to a preferred embodiment of the invention, the specific resistance of the ceramic thermistor element is 200 Ω·cm or less, the insulating layer comprises an acrylate resin, and the outer electrodes are formed by electrolytic plating. The ceramic layer contains by 10% or more as its principal component one or more oxides containing two or more metals selected from Mn, Ni, Co, Fe, Cu and Al and also one or more elements selected from Zn, Al, W, Zr, Sb, Y, Sm, Ti and Fe.

A method of producing such ceramic thermistor chips embodying this invention may be characterized as comprising the steps of stacking a specified number of thermistor ceramic green sheets, cutting and baking the stacked ceramic green sheets to obtain a ceramic thermistor element, forming an organic electrically insulating layer, such as of an acrylate resin, entirely covering the outer surfaces of the ceramic thermistor element except its mutually separated end parts and thereafter subjecting the ceramic thermistor element to an electrolytic plating process to thereby form electrolytically plated layers on these end parts.

Another method of producing such ceramic thermistor chips embodying this invention may be characterized as comprising the steps of stacking a specified number of thermistor ceramic green sheets, cutting the stacked ceramic green sheets to obtain a ceramic thermistor element, applying a ceramic material with a higher specific resistance than the thermistor ceramic green sheets entirely over the outer surfaces of the ceramic thermistor element except its mutually separated end parts, thereafter baking it and then subjecting it to an electrolytic plating process to thereby form electrolytically plated layers on these end parts.

### BRIEF DESCRIPTION OF THE DRAWINGS

The accompanying drawings, which are incorporated in and form a part of this specification, illustrate embodiments of the invention and, together with the description, serve to explain the principles of the invention. In the drawings:

FIG. 1 is a sectional view of a ceramic thermistor chip embodying this invention;

FIGS. 2A, 2B and 2C, together referred to as FIG. 2, are diagonal views of the ceramic thermistor chip of FIG. 1 at various stages of its production process, FIG. 2A showing its ceramic thermistor element after it has been sintered, FIG. 2B showing the ceramic thermistor element after it has been covered with an insulating resin, and FIG. 2C showing the ceramic thermistor chip with outer electrodes formed thereon;

FIG. 3 is a sectional view of another ceramic thermistor chip according to another embodiment of this invention;

FIGS. 4A, 4B and 4C are diagonal views of the ceramic thermistor chip of FIG. 3 at various stages of its production process, FIG. 4A showing its ceramic thermistor element before it is sintered, FIG. 4B showing the ceramic thermistor element after the high-resistivity layers have been formed, and FIG. 2C showing the ceramic thermistor chip with outer electrodes formed thereon; and

FIG. 5 is a sectional view of a prior art ceramic thermistor chip.

### DETAILED DESCRIPTION OF THE INVENTION

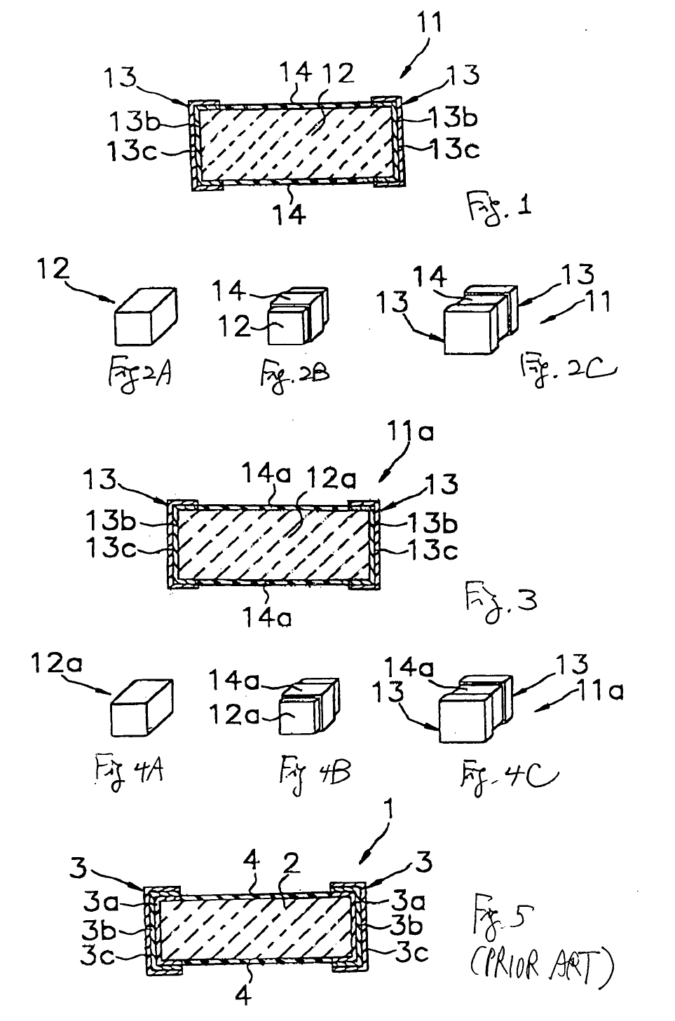

The invention is described next by way of an example. FIG. 1 shows a ceramic thermistor chip 11 embodying this invention, comprising a ceramic thermistor element 12, outer electrodes 13 formed on both end parts of the ceramic thermistor element 12 and insulating layers 14 covering the portions of the surfaces of the ceramic thermistor element 12 not covered by the outer electrodes 13. As shown in FIGS. 1 and 2A, the ceramic thermistor element 12 is of the shape of a quadrangular column, having two mutually oppositely facing end surfaces and two pairs each of mutually oppositely facing side surfaces perpendicular to the end surfaces. Throughout herein, expression “end parts” will be used to indicate the portions of the ceramic thermistor element 12 including not only the aforementioned end surfaces but also portions of the side surfaces immediately adjacent the end surfaces. In other words, the portions of the outer surface of the ceramic thermistor element 12 which are shown as being covered by the outer electrodes 13 in FIG. 1 are referred to as the end parts of the ceramic thermistor element 12.

These ceramic thermistor chips 11 are produced as follows. A thermistor material to be selected is a material having a specific resistance 200 Ω·cm or less, and one or more oxides containing two or more metals selected from Mn, Ni, Co, Fe, Cu and Al are its principal component (with content of 10% or more). Suitable amounts of an organic binder, a dispersant, a surface active agent, an anti-foaming agent and a solvent are added to this material to obtain ceramic green sheets of thickness about 40-60 μm which are cut into pieces of a specified size. A specified number of these sheets are piled up one on top of another and compressed with a hydraulic press so as to obtain an integrated body with a specified thickness. The integrated body thus obtained is cut into the size of the desired ceramic thermistor chip and baked at 1000-1300° C. to obtain ceramic thermistor elements as shown at 12 in FIG. 2A.

Next, as shown in FIG. 2B, an electrically insulating acrylate resin is coated, by a process such as pad printing, all over the four outer side surfaces of the ceramic thermistor element 12 except the portions where the outer electrodes 13 are later to be formed and it is thermally hardened to obtain the insulating layer 14. Acrylate resin materials are preferable according to this invention because it is more strongly resistant than the prior art glass layers against plating processes. A different kind of resin material may be used for this purpose as long as it is resistant against plating, such as acrylic acid resins, epoxy resins, fluorocarbon resins, silicone resins and vinyl resins.

Thereafter, as shown in FIGS. 1 and 2C, Ni layers 13b and Sn layers 13c are sequentially formed by an electrolytic barrel plating method on both end parts of the ceramic thermistor element 12.

FIG. 3 shows another ceramic thermistor chip 11a according to another embodiment of the invention. Its components which are substantially identical to those already explained above with reference to FIGS. 1 and 2 are indicated by the same symbols and will not be repetitiously explained for the simplicity of description.

The ceramic thermistor chip 11a of FIG. 3 comprises a ceramic thermistor element 12a, outer electrodes 13 formed on both end parts of the ceramic thermistor element 12a and high-resistivity layers 14a covering the portions of the outer side surfaces of the ceramic thermistor element 12a not covered by the outer electrodes 13. This ceramic thermistor chip 11a may be produced as follows. Firstly, ceramic green sheets are produced as explained above for the production of the ceramic thermistor chip 11 shown in FIG. 1 and a specified number of these ceramic green sheets are piled up one on top of another and compressed together with a hydraulic press such that an integral body with a desired thickness is obtained. The integral body thus produced is cut to a desired size to produce a ceramic thermistor chip of the desired size as shown in FIG. 4A.

Next, a ceramic material of the same kind as that of the ceramic thermistor element 12a but having a higher specific resistance is prepared. Described more in detail, a ceramic thermistor material in the form of a paste having as its principal component (that is, with content more than 10%) one or more oxides containing at least two metals selected from Mn, Ni, Co, Fe, Cu and Al and containing also at least one selected from Zn, Al, W, Zr, Sb, Y, Sm, Ti and Fe is prepared. This ceramic thermistor material is characterized as having a higher specific resistance than the ceramic thermistor element 12a, and it is applied, by a process such as pad printing, onto the four outer side surfaces of the ceramic thermistor element 12a except for the portions where the outer electrodes 13 are later to be formed. Thereafter, the ceramic thermistor element 12a thus prepared is baked at 1000-1300° C. to obtain the ceramic thermistor element 12a as shown in FIG. 4B. In summary, a high-resistivity material is printed on the four outer side surfaces of the ceramic thermistor element 12a and then is baked together with the ceramic thermistor element 12a such that the desired high-resistivity layers 14a covering the four side surfaces of the ceramic thermistor element 12a like a belt can be obtained.

Thereafter, as shown in FIGS. 3 and 4C, Ni layers 13b and Sn layers 13c are sequentially formed by an electrolytic barrel plating method on both end parts of the ceramic thermistor element 12a to obtain the ceramic thermistor chip 11a shown in FIG. 3.

Although the invention has been described above in terms of only two examples, these examples are intended to be demonstrative and illustrative, not to be limiting the scope of the invention. Many modifications and variations are possible within the scope of the invention. For example, the outer electrodes 13 according to this invention are required to be electrolytically plated electrodes but need not comprise Ni and Sn. The ceramic thermistor chips according to this invention may include inner electrodes. Such inner electrodes may be formed, for example, by preparing them on the surface of the green sheets before these sheets are piled up one on top of another. It also goes without saying that the invention may relate to both positive and negative temperature coefficient thermistor chips.

In summary, ceramic thermistor chips according to this invention have organic insulating layers or high-resistivity layers formed on otherwise exposed surface portions of the ceramic thermistor element and hence the corrosion of the element at the time of electrolytic plating, degradation of the element affecting its strength against breaking and adverse effects on reliability can be prevented. Since the outer electrodes are formed without using thick-film Ag paste but only by electrolytic plating, furthermore, the outer electrodes of the present invention can be formed at a lower cost while having an improved resistance against the heat of soldering.

What is claimed is:

1. A ceramic thermistor chip comprising:
a ceramic thermistor element with outer surfaces including two end parts away from each other;
outer electrodes covering said end parts of said thermistor element; and
a high-resistance layer with a higher specific resistance than said ceramic thermistor element entirely covering said outer surfaces of said ceramic thermistor element except where said outer electrodes are formed.

2. The ceramic thermistor chip of claim 1 wherein said high-resistance layer comprises an electrically insulating organic material.

3. The ceramic thermistor chip of claim 2 wherein said high-resistance layer comprises an acrylate resin.

4. The ceramic thermistor chip of claim 1 wherein said thermistor element has a principal component contained by 10% or more and said high-resistance layer comprises a ceramic layer which has the same principal component by 10% or more.

5. The ceramic thermistor chip of claim 2 wherein said ceramic thermistor element has a specific resistance lower than 200 Ω·cm.

6. The ceramic thermistor chip of claim 1 wherein said high-resistance layer comprises one or more oxides containing two or more metals selected from the group consisting of Mn, Ni, Co, Fe, Cu and Al and also at least one metal selected from the group consisting of Zn, Al, W, Zr, Sb, Y, Sm, Ti and Fe.

7. The ceramic thermistor chip of claim 4 wherein said high-resistance layer comprises one or more oxides containing two or more metals selected from the group consisting of Mn, Ni, Co, Fe, Cu and Al and also at least one metal selected from the group consisting of Zn, Al, W, Zr, Sb, Y, Sm, Ti and Fe.

8. The ceramic thermistor chip of claim 5 wherein said high-resistance layer comprises one or more oxides containing two or more metals selected from the group consisting of Mn, Ni, Co, Fe, Cu and Al and also at least one metal selected from the group consisting of Zn, Al, W, Zr, Sb, Y, Sm, Ti and Fe.

9. The ceramic thermistor chip of claim 1 wherein said outer electrodes comprise electrolytically plated layers.

10. A method of producing a ceramic thermistor chip, said method comprising the steps of:
stacking a specified number of thermistor ceramic green sheets;
cutting and baking the stacked ceramic green sheets to obtain a ceramic thermistor element, said ceramic thermistor element having outer surfaces including two end parts away from each other;
forming a high-resistance layer entirely covering said outer surfaces of said ceramic thermistor element except said end parts;
thereafter subjecting said ceramic thermistor element to an electrolytic plating process to thereby form electrolytically plated layers on said end parts whereby said outer surfaces of said ceramic thermistor element are entirely covered by said high-resistance layer except where said electrolytically plated layers are formed.

11. The method of claim 10 wherein said high-resistance layer comprises an electrically insulating organic material.

12. The method of claim 11 wherein said high-resistance layer comprises an acrylate resin.

13. A method of producing a ceramic thermistor chip, said method comprising the steps of:
stacking a specified number of thermistor ceramic green sheets;
cutting the stacked ceramic green sheets to obtain a ceramic thermistor element, said ceramic thermistor element having outer surfaces including two end parts away from each other;
applying a ceramic material, having a higher specific resistance than said thermistor ceramic green sheets, entirely over said outer surfaces of said ceramic thermistor element except said end parts;
thereafter baking said ceramic thermistor element with said ceramic material applied thereon; and
thereafter subjecting said baked ceramic thermistor element to an electrolytic plating process to thereby form electrolytically plated layers on said end parts whereby said outer surfaces of said ceramic thermistor element are entirely covered by said high-resistance layer except where said electrolytically plated layers are formed.

14. The method of claim 13 wherein said ceramic layer and said thermistor element both have a same principal component by 10% or more.

15. The method of claim 13 wherein said ceramic thermistor element has a specific resistance lower than 200 Ω·cm.

16. The method of claim 13 wherein said ceramic layer comprises one or more oxides containing two or more metals selected from the group consisting of Mn, Ni, Co, Fe, Cu and Al and also at least one metal selected from the group consisting of Zn, Al, W, Zr, Sb, Y, Sm, Ti and Fe.

17. The method of claim 15 wherein said ceramic layer comprises one or more oxides containing two or more metals selected from the group consisting of Mn, Ni, Co, Fe, Cu and Al and also at least one metal selected from the group consisting of Zn, Al, W, Zr, Sb, Y, Sm, Ti and Fe.

18. The method of claim 14 wherein said principal component consists of one or more oxides containing two or more metals selected from the group consisting of Mn, Ni, Co, Fe, Cu and Al and also at least one metal selected from the group consisting of Zn, Al, W, Zr, Sb, Y, Sm, Ti and Fe.
